(19) United States
(12) Patent Application Publication
(10) Pub. No.: US 2024/0383491 A1
(43) Pub. Date: Nov. 21, 2024

(54) AUTOMATED DATA ENTRY AND ERROR CHECKING METHODOLOGY FOR GENERATING STATE TRANSITION TABLES

(71) Applicant: GM GLOBAL TECHNOLOGY OPERATIONS LLC, Detroit, MI (US)

(72) Inventors: Yael Shmueli Friedland, Tel Aviv (IL); Shani Avnet, Tel Aviv (IL); Daniel Y. Rubin, Holon (IL); Asaf Degani, Tel Aviv (IL)

(73) Assignee: GM GLOBAL TECHNOLOGY OPERATIONS LLC, Detroit, MI (US)

(21) Appl. No.: 18/318,006

(22) Filed: May 16, 2023

(51) Int. Cl. B60W 50/14; G06F 3/0486

(52) U.S. Cl. CPC B60W 50/14; G06F 3/0486; B60W 2050/0016; B60W 2050/0026; B60W 2050/146

(57) ABSTRACT

A method for generating a populated state transition table for a finite-state machine (FSM)-modeled system includes receiving system traits via a host computer of a modeling system. The system traits include states, state transitions, and events of the FSM-modeled system. The method includes generating an initial state transition table in response to receipt of the system traits, the table being partially-populated by the system traits. The method additionally includes populating the table in response to user inputs to thereby auto-generate a populated state transition table, and error-checking the populated table using predetermined error-checking criteria, including searching the populated table via error-checking logic of the host computer for an omitted critical trait of the FSM-modeled system. The method also includes communicating an alert to the user in response to the omitted critical trait.

### INTRODUCTION

The present disclosure relates to a software-based design toolbox and data entry methodology for aiding a designer, programmer, or another user in the design and verification of finite state machine-modeled systems, particularly those having complex behavioral traits.

As appreciated by those skilled in the art, finite state machines are mathematical abstractions frequently used to design and validate the expected behavior of a myriad of different software programs and physical systems. A finite state machine may be graphically represented as a state diagram having an initial state, one or more additional states, associated state transitions, and various inputs or events. Based on the present state of the modeled system and a given event or event combination, a finite state machine performs one or more of the state transitions. A finite state machines may be programmed and executed in software, with a corresponding state transition table capturing the above-noted states, state transitions, and triggering events. The state transition table is then used as a performance model of the underlying system.

### SUMMARY

Disclosed herein are automated systems and associated methods for aiding a user, e.g., a software programmer, a designer, or a system developer, in the design of a finite state machine (FSM) model of an underlying system. The methodology contemplated herein is particularly well suited for modeling systems having complex behavioral traits, e.g., a wide range of possible states, state transitions, events, and other possible traits as noted above. For instance, motor vehicles having automation control capabilities have complex modes and transition rules. Some of these modes are executed automatically or in response to driver inputs, while other modes are based on timers, hidden logic, or other automatically occurring activation criteria. Due to this complexity and the criticality of achieving as close to a perfect understanding of the modeled system as possible, it is necessary to verify that the underlying system and associated human-machine interfaces have been properly and fully designed. The present solutions make it possible to identify omissions and inconsistencies in the finite state model, as well as locations or conditions where the finite state model is not fully specified.

To this end, a method is disclosed herein for guiding or assisting a user when modeling a system. An embodiment of the method includes receiving system traits via a host computer, with the system traits including system states, events, super-events (event combinations), a hierarchy definition, state transitions, and possibly other system traits. The method includes generating an initial state transition table in response to the system traits, with this action occurring via the host computer. The finite state table is indexed by a complete population of possible states and events of the FSM-modeled system, and is partially-populated with the system traits entered by the user. Embodiments of the method also include populating the initial state transition table, via the host computer, in response to a set of user inputs. This action includes auto-generating a populated state transition table.

The method may include performing error-checking of the populated state transition table using predetermined error-checking criteria, including searching the populated state transition table via the host computer for an omitted state transition. The host computer may communicate an alert to the user in response to the omitted state transition. Additional error-checking functionality within the scope of the disclosure may include validation of state transitions per event type for states that belong to a certain container as described herein, and highlighting critical events and states to help identify transitions of critical events to non-critical events, and in general, to look more thoroughly at such highlighted transitions.

A non-limiting representative implementation of the method includes receiving system traits via a host computer from a user, the system traits including states, state transitions, and events of the modeled system. The method also includes generating an initial state transition table in response to receipt of the system traits, the initial state transition table being partially-populated by the system traits, and populating the initial state transition table, via the host computer, in response to a set of user inputs from a user of the host computer, to thereby auto-generate the populated state transition table. Additionally, the method includes error-checking the populated state transition table using predetermined error-checking criteria, including searching the populated state transition table via error-checking logic of the host computer for an omitted critical trait of the modeled system. An alert may then be communicated to the user of the host computer in response to the omitted critical trait.

Receiving the system traits could include receiving User-initiated events, System-triggered events, and Timeout events of the modeled system.

The method may also include iteratively performing the method until the host computer does not detect the omitted critical trait, and then outputting the populated state transition table as a final state transition table once the host computer does not detect the omitted critical trait.

Embodiments of the method include presenting a menu of possible states and events of the modeled system to the user via a display screen of the host computer, as well as determining the system traits via the host computer using touch or keyboard inputs. The method may optionally include displaying the menu as a drop-down list. In such an embodiment, receiving the system traits includes recording user entries or selections from the drop-down list.

An aspect of the disclosure includes receiving, via the host computer, one or more containers of meaning (“containers”) in which two or more of the states are grouped together, and translating the containers into a state hierarchy. The method may also include displaying an intuitive drag-and-drop graphic or editing tools to the user via a display screen of the host computer, and also receiving the one of more containers of meaning as a user response to the drag-and-drop graphic or editing inputs from the editing tools. Aspects of the method could include confirming, via the host computer, a validity of the state transitions per event type in each respective one of the containers. A validity confirmation status could also be communicated to the user in response to confirming the validity of the state transitions per event type.

In a possible implementation, the method may include receiving a user-defined compound event as a combination of the events, and then updating the populated state transition table with the user-defined compound event.

Another possible implementation of the method includes receiving a customized event query from the user via the host computer, the customized event query describing one or more hypothetical combinations of the events. The method may also include determining results of the event query via the host computer, and updating the populated state transition table with the results.

Another aspect of the present disclosure includes a modeling system for generating a populated state transition table for a modeled system. An embodiment of the modeling system includes a host computer having a non-transitory computer-readable storage medium (“memory”) and a processor, with the memory including an instruction set that is executable by the processor. A display screen is in communication with the host computer. Execution of the instruction set by the processor causes the host computer to receive system traits from a user of the host computer, including states, state transitions, and events of the modeled system, and to generate an initial state transition table in response to receipt of the system traits, the initial state transition table being partially-populated by the system traits. Execution of the instruction set also causes the processor to populate the initial state transition table in response to a set of user inputs to thereby auto-generate the populated state transition table, error-check the populated state transition table using predetermined error-checking criteria, including searching the populated state transition table via error-checking logic of the host computer for an omitted critical trait of the modeled system, and communicate an alert to the user of the host computer in response to the omitted critical trait.

Also disclosed herein is a computer-readable storage medium on which is recorded instructions that are executable by a processor. Execution of the recorded instructions causes the processor to perform the above-summarized steps.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure. The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

FIG. 1 illustrates a modeling system for finite state modeling of an underlying system, with the modeling system being configured to perform a data entry and automatic error-checking methodology when creating state transition tables.

FIG. 1A illustrates an exemplary embodiment of distributed processing nodes for use in implementing the modeling system of FIG. 1.

FIG. 2 illustrates an exemplary screen for an event definition stage of the methodology described herein in which events/inputs are defined by a user of the representative modeling system depicted in FIG. 1.

FIG. 3 illustrates another exemplary screen for performing the event definition stage of FIG. 2.

FIG. 4 illustrates a possible screen for use in a state definition stage according to an exemplary approach.

FIG. 5 illustrates a function of the modeling system of FIG. 1 when grouping states into different containers of meaning in accordance with an aspect of the disclosure.

FIG. 6 depicts a possible implementation of a compound/super-event definition stage usable as part of the present strategy.

FIG. 7 is a simplified representative state transition table in accordance with an aspect of the disclosure.

FIG. 8 illustrates a possible approach for implementing customed queries via the modeling system of FIG. 1.

FIG. 9 is a flow chart describing an embodiment of a data entry and automatic error checking using the modeling system of FIG. 1.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

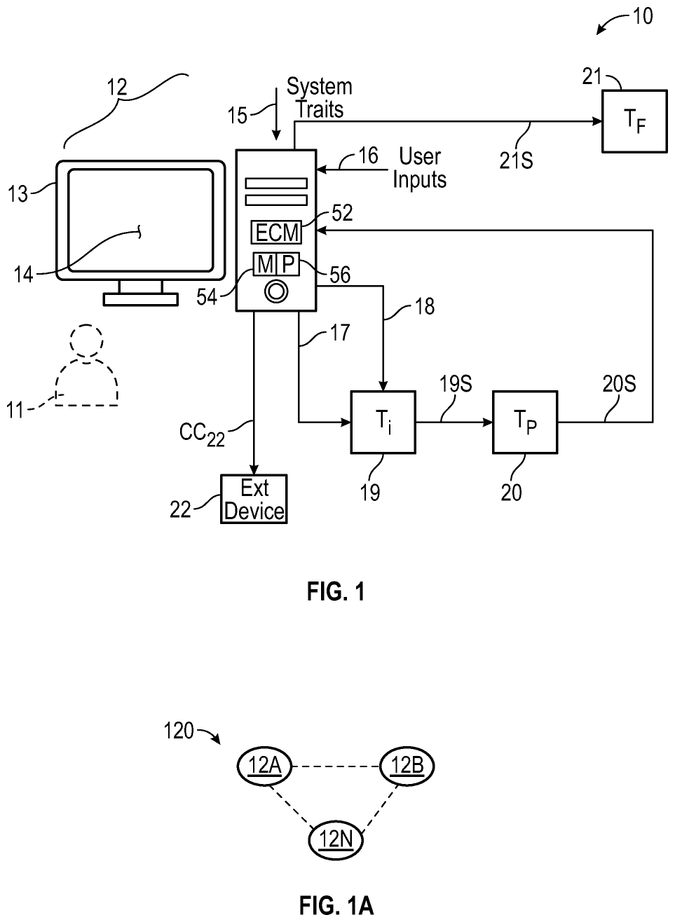

Referring to the drawings, wherein like reference numbers refer to like features throughout the several views, FIG. 1 depicts a computerized modeling system 10 for performing data entry and automatic error-checking during the design of a finite state model (FSM). The modeling system 10 of FIG. 1 includes a host computer 12, e.g., a laptop computer, tablet computer, desktop computer, mobile application (“app”), etc., that is configured for assisting a designer, programmer, or another user 11 when modeling a complex hardware and/or software-based system (“FSM-modeled system”). Although the host computer 12 is depicted as a single device for illustrative simplicity, those skilled in the art will appreciate that the host computer 12 could be implemented as a distributed host computer system 120 having multiple processing nodes, e.g., 12A, 12B, . . . , 12N, as depicted schematically in FIG. 1A. Such processing nodes may be in communication with one another over a suitable wired or wireless networked connection. The modeling system 10 could be used to model performance of a human-machine interface (“HMI”) or another device aboard a motor vehicle or an aircraft, watercraft, rail vehicle, or another dynamic system, or to model performance of a medical device, powerplant, or another static system.

The modeling system 10 of FIG. 1 may include one or more peripheral devices 13, including a display screen 14 operable as an output device for the host computer 12. The user 11 may interact with the host computer 12 via one or more additional peripheral devices 13 (not shown), e.g., a mouse, keyboard, touch inputs to the display screen 14, etc., when developing or designing state transition tables for the FSM-modeled system, including functions of resident software and/or hardware thereof.

As appreciated in the art, the task faced by the user 11 when designing an application-suitable FSM model is often complicated by the sheer complexity of the FSM-modeled system. For example, while operation of a binary system such as an on/off table lamp could be represented by its two possible states (“on” and “off”), two possible state transitions (“on-to-off” and “off-to-on”), and two inputs or events (“switch turned off” and “switch turned on”), the accurate FSM modeling of more complex systems could require the same user 11 to consider hundreds or thousands of different states, state transitions, events, and other possible system traits. It is thus possible that the user 11 could inadvertently overlook or omit one or more states, state transitions, or event combinations (“super-events”), which in turn could degrade the performance and quality of the modeled system. The present solutions are therefore intended to facilitate the design and development of FSMs and corresponding state transition tables to allows the user 11 to fully define the possible states, set a hierarchy of such states in an intuitive manner, and ultimately construct and error-test the state transition table in a comprehensive manner. Among the many possible attendant benefits of the present solutions, the user 11 is guided into considering function-critical states with highlighting of potential errors or omissions (“critical traits”). As noted above, additional error-checking functionality may be provided within the scope of the disclosure, including validation of state transitions per event type for states that belong to a certain container as described below, and highlighting critical events and states to help identify transitions of critical events to non-critical events, and in general, to look more thoroughly at such highlighted transitions.

As part of the present strategy, the host computer 12 of FIG. 1 or its constituent processing nodes 12A, 12B, . . . , 12N of FIG. 1A may be equipped with an error-checking module (“ECM”) 52, non-tangible computer-readable storage medium or memory (M) 54, and one or more processors (P) 53, e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described functionality. The associated memory 54 may include application-suitable amounts and types of non-transitory memory inclusive of read only, programmable read only, random access, a hard drive, etc., whether resident, remote or a combination of both.

As described herein, the host computer 12 is configured to receive system traits 15 from the user 11. This could entail receiving various states, state transitions, and events of the modeled system, along with a possible super-events (event combinations), a hierarchy definition, and other system traits 15. In response to the received system traits 15, the host computer 12 automatically generates and outputs a first data set 17 embodying a blank/unpopulated initial state transition table (Ti) 19. This initial state transition table 19 is indexed by as complete of a population of possible states and events of the modeled system as possible, and with the system traits 15 entered by the user 11. Additionally, the host computer 12 automatically populates the initial state transition table 19 with a second data set 18 to thereby generate a third data set 19S, the third data set 19S including a populated state transition table (“T_{P}”) 20.

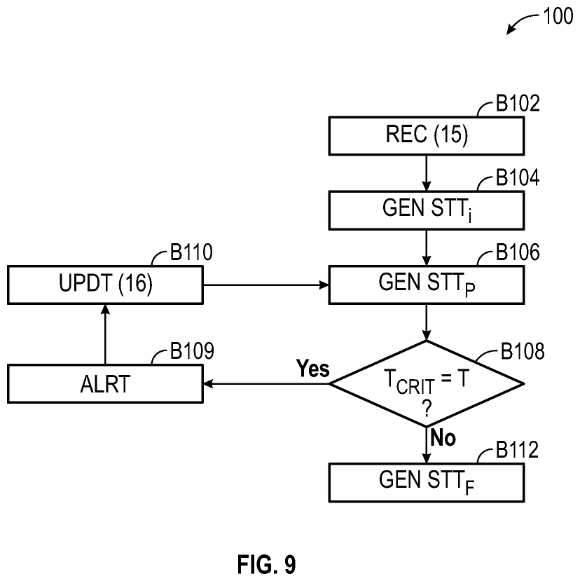

That is, the host computer 12 automatically generates (“auto-generates”) the populated state transition table 20 as the third data set 19S. This occurs in response to a set of user inputs 16. After performing one or more iterations of a method 100, an example of which is described below with reference to FIG. 9, the host computer 12 ultimately outputs a final state transition table (T_{F}) 21. The final state transition table 21 is then used as needed, typically as a starting point for further investigation by the user 11 and to serve as a basis for developing a state diagram and scenario simulations for the modeled system.

As part of the disclosed solutions, the host computer 12 shown schematically in FIG. 1 processes the third data set 19S through the ECM 52 to error-check the populated state transition table 20. This action occurs using predetermined error-checking criteria. For instance, the host computer 12 could search the populated state transition table 20 for omitted critical traits, e.g., an omitted state, state transition, event, and/or other trait(s) of a system-critical or function-critical component of the modeled system. The host computer 12 may also communicate an alert signal (CC₂₂) to the display screen 14 or to an external device (“Ext Device”) 22 such as a smart phone or one of the various processing nodes 12A, 12B, . . . , 12N of FIG. 1A as part of the present strategy as noted below, which such an action occurring in response to the omitted critical trait.

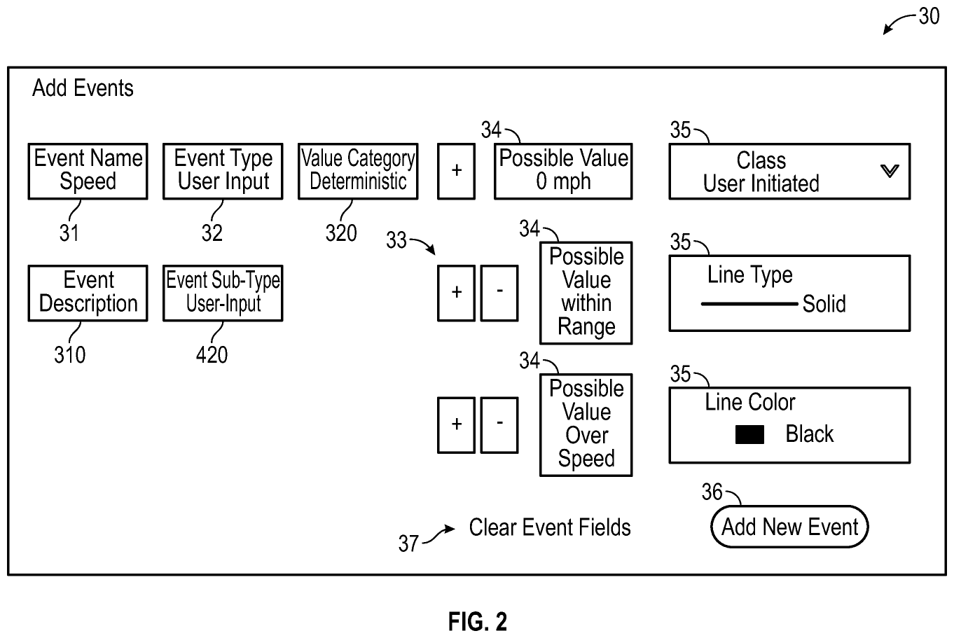

Additional error-checking functionality may be included, such as the aforementioned validation of state transitions per event type for states that belong to a certain container as described herein, and highlighting critical events and states to help identify transitions of critical events to non-critical. A non-limiting exemplary implementation or method 100 in accordance with the present teachings is shown in FIG. 9. As will be appreciated by those skilled in the art having the benefit of the forgoing disclosure, the method 100 and its execution by the host computer 12 provide an improvement in computer-related technology related to FSM-based modeling of systems and associated functions. This improvement is achieved in part by enabling computer performance of functions not previously performable in this capacity. The particular solutions set forth above with reference to FIGS. 1-8 achieve the desired outcome of a complete and error-proofed state transition table, i.e., the final state transition table 21. Constituent stages of the method 100 will now be described with reference to FIGS. 2-8.

DEFINING EVENTS: referring now to FIG. 2, a representative event input screen 30 could be presented to the user 11 via the display screen 14 of FIG. 1 as part of the present approach. An aim of this particular step is to properly define the events in the modeled system. To that end: (1) events are organized into one of three categories: (i) User-initiated, (ii) System-triggered, and (iii) Timeout; (2) the event type will be (i) a user event (for the User-initiated category), (ii) a machine status, sensor status, environmental conditions, external event, etc. (for the System-triggered category), or (iii) user readiness, triggered timer, and independent timer (for the Timeout event category). Finally, (3) the value with be (i) Deterministic, as string of text and/or numbers, (ii) Boolean, i.e., true or false, or (iii) Integer, including logical properties such as ≥, <, =, etc.

Before the user 11 enters the system traits 15, the host computer 12 could first present the input screen 30 as a set of user-selectable buttons. For instance, the user 11 could add a new event via an Event Name button 31, which is labeled “speed” in FIG. 2 to describe a non-limiting example event in which the modeled system is a motor vehicle. An Event Description button 310 may be used to further define the event. A Value Category button 320, e.g., deterministic as shown, could be present on the representative “Add Events” screen of FIG. 2. The user 11 could then define the event type via an Event Type button 32 and an Event Sub-Type button 420, e.g., “User-input” as shown, selecting an add or “+” action via a corresponding selection button 33. Value Buttons 34 could be selected to add corresponding possible values, e.g., “0 mph”, “within range”, and “over speed” in the illustrated example of FIG. 2.

The input screen 30 could likewise present several Event Class buttons 35 to enable the user 11 to define whether a given event is a user-initiated category as specified above, or automatically-occurring such as in response to a timer, external/environmental, fault-triggered, etc. The various classes could be assigned a given line weight/style (dashed, solid, dotted, etc.) or color, which are then used to connect states in a corresponding state transition diagram. Additional buttons could be used with input screen 30 of FIG. 2 for other purposes, such as but not limited to an Add New Event button 36 and a Clear Event Fields button 37.

Collectively, the buttons 31-37 in the non-limiting embodiment of FIG. 2 allow the user 11 of FIG. 1 to initially define the events or inputs for use by the host computer 12 of FIG. 1 when constructing a state transition diagram of a modeled system. The method 100 could include presenting a menu of possible states and events of the modeled system via the display screen 14, with the menu possibly being configured to receive touch or keyboard inputs from the user 11, and then determining the system traits 15 noted above using such touch or keyboard inputs. This could include displaying the menu as a drop-down list, in which case receiving the system traits 15 includes recording user entries or selections from the drop-down list, e.g., in the memory 54 of the host computer 12. The user 11 could also restrict values according to their appropriateness to the above-noted Value category.

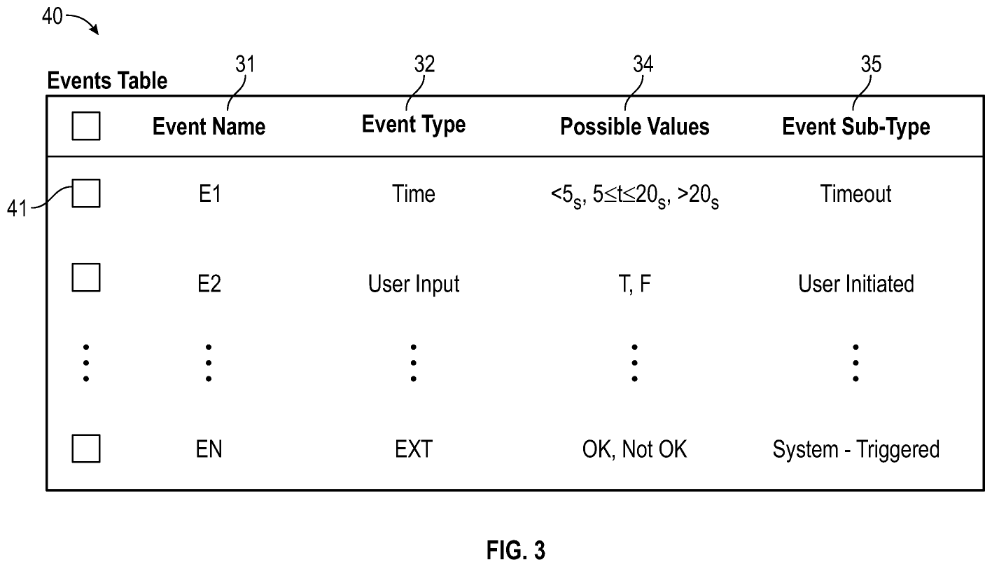

Referring briefly to a representative Events Table screen 40 of FIG. 3, in response to completion of data entry using the exemplary input screen 30 of FIG. 2, the host computer 12 could present a representative event screen 40 via the display screen 14 of FIG. 1. Possible event values as described above include Deterministic, Boolean, and Integer. To that end, the Events Table screen 40 could include columns corresponding to the above-described buttons of FIG. 2, e.g., an Event Name button 31, Event Type button 32, Possible Values button 34, and Event Sub-type button 35. The event screen 40 could also include selection boxes 41 corresponding to each event name, e.g., nominal events E1, E2, . . . , EN.

Non-limiting exemplary event types for a representative modeled system include user events (for the User-initiated category), machine status, sensor status, environmental conditions, external events, etc., (for the System-triggered event category), or user readiness, triggered timer, and independent timer for the Timeout event as noted above. As an illustration of some of these events, “Time” represents a nominal timeout event E1, “User Input” a nominal user event E2, and “Ext” represents the N^{th} nominal event EN, e.g., an external event or environmental event. Possible Values 34 for nominal event E1 in this representative case may be one or more time thresholds or ranges, such as with the illustrated example ranges of <5 s, 5 s≤t≤20 s, >20 s, or true or false (T, F) for nominal event E2, or “OK, Not OK” for nominal event EN. Exemplary class events that may be entered by the user 11 via the Class (or Event) button 35 may include, by way of an example, “User-Initiated”, “System-Triggered” as shown, or “Timeout”. Thus, the representative event screen 40 could present events for each state transition, which the user 11 of FIG. 1 may edit from the event screen 40 simply by adding, deleting, or modifying one or more of the rows.

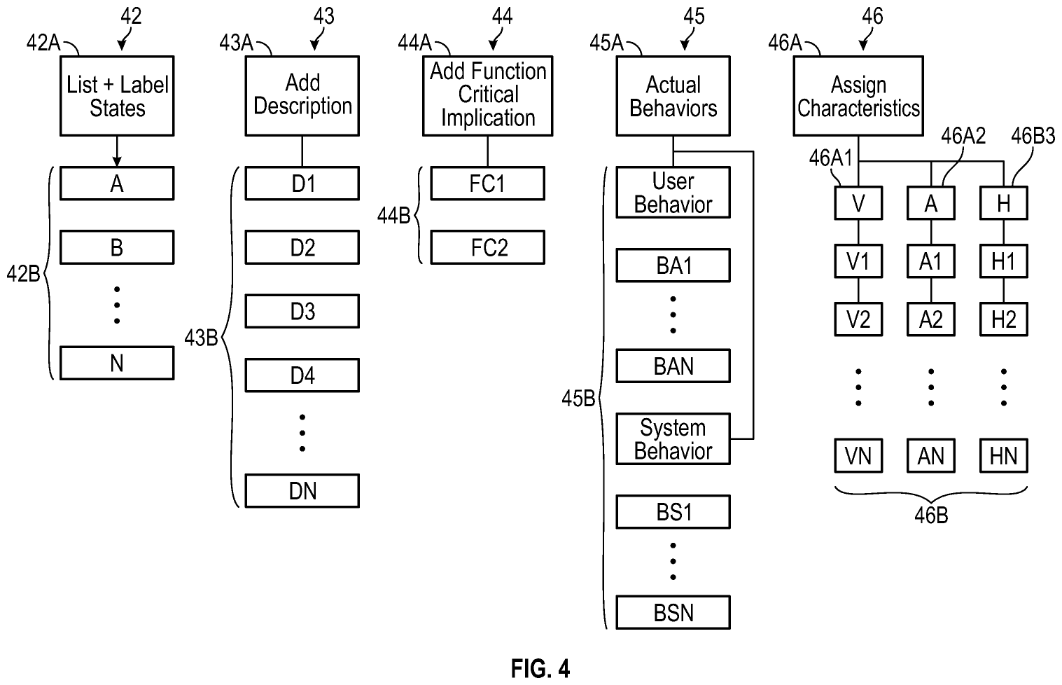

DEFINING STATES: as illustrated in FIG. 4, the possible states of the finite state-modeled system may be defined by the user 11 of FIG. 1 using the host computer 12. In a non-limiting illustrative example, the user 11 may view and select from a “List+Label States” column 42 having a main selection button 42A from which the user 11 is able to select or enter multiple states 42B, e.g., nominal states A, B, . . . , N, with the identity of the states being application-dependent as appreciated in the art. An “Add Description” column 43 with a main selection button 43B enabled the user 11 to select one or more corresponding state descriptions 43B labeled as nominal state descriptions D1, D2, D3, D4, . . . , DN. In keeping with the non-limiting embodiment of a motor vehicle as the modeled system, for instance, such descriptions could include “available” (or “standby”), “active”, “escalation”, etc. Additionally, the user 11 could utilize an “Add Critical Function” column 44 with main selection button 44A to define critical functions or implications 44B labeled as nominal functions FC1 and FC2, e.g., responsiveness levels of an end-user or system.

Still referring to FIG. 4, the user 11 of FIG. 1 could also view and edit an “Actual Behaviors” column 45 with a corresponding main selection button 45A to define behaviors 45B, e.g., nominal user behaviors BA1, . . . , BAN and/or nominal system behaviors BS1, . . . , BSN. Representative user behaviors in the same vein as the above-summarized motor vehicle illustrative example may include “full control”, “lateral control”, “longitudinal control”, “no control”, etc., with representative system behaviors possibly including, e.g., “maintain speed”, “coasting”, or “smart deceleration”, among many other possible application-specific behaviors. In addition to columns 42, 43, 44, and 45, the user 11 shown in FIG. 1 could use an “Assign Characteristics” column 46 and a main selection button 46A to assign characteristics 46B. Such characteristics could be arranged as distinct types such as visual characteristics (V) 46B1, auditory characteristics (A) 46B2, and haptic characteristics (H) 45B3, with each of the characteristic types having one or more selected characteristics.

For example, the user 11 could select, for the visual characteristics 46B1, a list of specific nominal visual characteristics V1, V2, . . . . VN, e.g., “color”, “saturation”, “amplitude”, “envelope shape”, etc. Similarly, the auditory characteristics 46B2 could include nominal auditory characteristics A1, A2, . . . , AN, for example “timbre”, “frequency”, “envelope shape”, “directionality”, and the like. The haptic characteristics 45B3 for their part could include nominal haptic characteristics H1, H2, . . . , HN. The user 11 is thus able to define the various system states for use by the host computer 12 in generating and iteratively error-checking and updating one or more state transition tables.

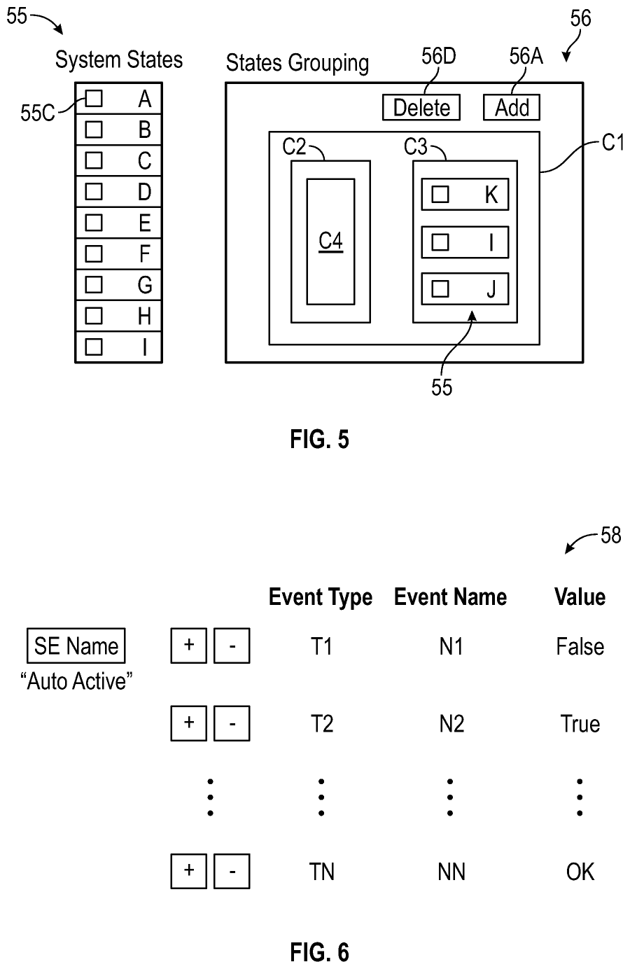

GROUPING OF STATES: referring now to FIG. 5, the host computer 12 depicted in FIG. 1 could then present to the user 11 a complete list of the previously-selected system states 55, which are labeled as nominal states A-I for simplicity. Each of the states 55 has a corresponding selection box 550 in this representative implementation, which when selected would allow the user 11 to select and manipulate the states 55 into a desired hierarchy. The host computer 12 in one or more embodiments receive user-defined containers of meaning (“containers”) in which two or more of the states 55 from FIG. 4 are grouped together. The host computer 12 could then translate the user-assigned containers into a corresponding state hierarchy.

To facilitate this optional approach, the host computer 12 could be configured to display an intuitive drag-and-drop graphic 56 via the display screen 14 shown in FIG. 1, for instance as rectangular containers C1, C2, C3, and C4. The host computer 12 could then group one or more of the illustrated example containers C1, C2, C3, and/or C4 as a user response to the drag-and-drop graphic 56. For example, the exemplary states 55 nominally labeled as K, I, and J in FIG. 5 could be arranged into the container C3, with the container C1 containing containers C2 and C3, and container C2 including an (empty) container C4. The user 11 can thus construct a hierarchy of states in an intuitive manner, with functions such as “Delete” and “Add” included via corresponding buttons 56D and 56A to add and delete new containers. Adding or deleting States to/from the containers could be performed using a “drag & drop” function, or possibly using typical cut, copy, and paste editing tools functions. The host computer 12 could also confirm the validity of the various state transitions per event type in each respective one of the containers as an added function, thereafter communicating a validity confirmation status to the user 11, e.g., as part of the alert signal (CC₂₂) of FIG. 1, with this action occurring in response to confirming the validity of the state transitions.

DEFINING SUPER-EVENTS: the user 11 of FIG. 1 in accordance with the disclosure could also combine multiple inputs or events, such as concurrent user-generated, automatically-generated, or environmentally-generated/externally-generated events. This action may entail receiving, via the host computer 12, a user-defined compound event or “super-event” as a combination of two or more previously-defined events. For instance, the user 11 could note the specific conditions that must occur before the modeled system is able to transition to a new state, such as from nominal state A of FIG. 5 to nominal state B. As an example, even though every other condition has been satisfied for transitioning from state A to state B, a “blocked camera” condition could prevent the modeled system from transitioning to an “automatic drive mode” in an exemplary motor vehicle use case. The host computer 12 could then update the populated state transition table 20 of FIG. 1 with the user-defined compound events in accordance with an aspect of the disclosure.

Referring to FIG. 6, the above-noted super-events could be constructed by the user 11 of the host computer 12 of FIG. 1 using yet another user screen 58. Here, the user 11 could define a super-event name such as “auto-active”, add or delete an event type using corresponding “+” or “−” buttons, and define the event type(s) associated with each new super-event. For example, nominal event types T1, T2, . . . . TN could be considered together as part of an “Auto Active” super-event, with assigned nominal event names N1, N2, . . . , NN and associated values, e.g., “False”, or “True”, . . . “OK”, etc. The user 11 could therefore use the illustrated screen 58 as an aid toward developing one or more super-events as part of the present approach, which would enable automated error checking functionality while avoiding conflicting or racing conditions. The user 11 would also be free to explore possible multiplications of events and export the results to the updated state transition table 20 of FIG. 1. This approach would also highlight interesting interactions between critical events.

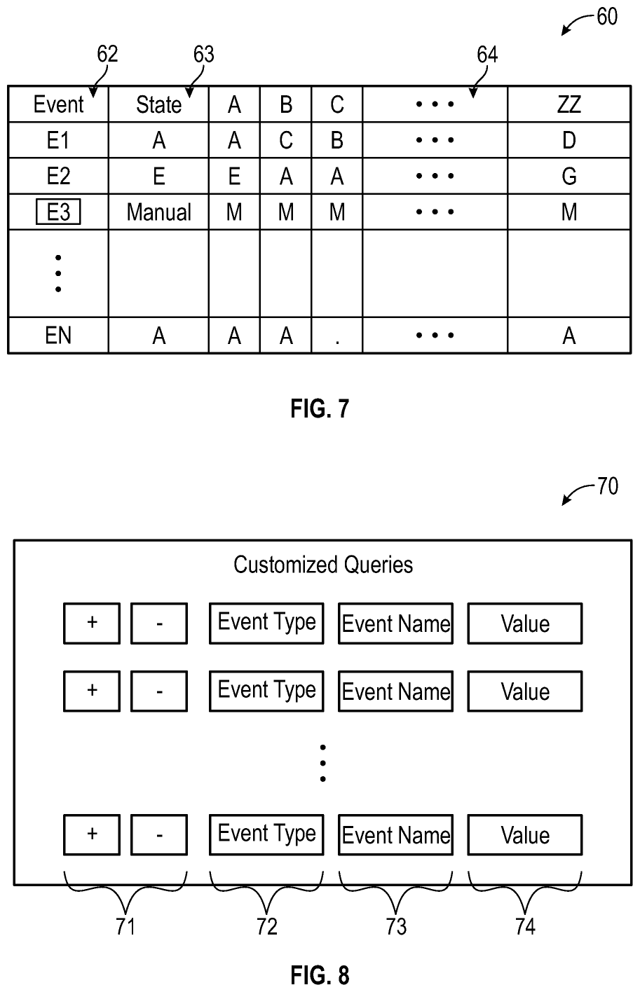

GENERATING STATE TRANSITION TABLE: referring to FIG. 7, the various state tables 19, 20, and 21 shown schematically in FIG. 1 may be visualized as a simplified state transition table 60. In this exemplary illustration, the state transition table 60 is organized into a row of nominal states 64, e.g., A, B, C, . . . . ZZ for simplicity, and an “event” column 62 containing nominal events E1, E2, E3, . . . , EN, with events described above with reference to FIGS. 2 and 3. Each event in column 62 in turn could trigger a transition to a corresponding state in column 63. For instance, event E2 occurring in state A could cause the modeled system to transition to state E in the illustrated state transition table 60. As part of the present approach, each of the states defined by the user 11 are listed in the exemplary state transition table 60.

In a possible approach, super-events as described above could be color-coded to distinguish them from regular events when displayed in the state transition table 60 of FIG. 7. Additionally, the user 11 is able to access the state transition table 60 and edit it directly, for example in response to a prompt from the host computer 12 of FIG. 1 indicating an omitted critical state, state transition, or event. That is, the host computer 12 could allow the user 11 to edit the state transition table 60 from within, e.g., by opening a drop-down menu in response to the user 11 selecting a particular state or event from the state transition table 60. This functionality is illustrated for simplicity at nominal event E3, via its boxed outline, and the notation “Manual” or “M” indicating the possibility of the user 11 editing or entering corresponding states into the state transition table 60. The user 11 is thus guided when constructing, populating, error-checking, and updating the state transition table 60, with such actions occurring iteratively through the method 100 described below with reference to FIG. 9.

The host computer 12 of FIG. 1 could, after displaying the state transition table 60 of FIG. 7, highlight omitted critical states or other critical traits, as well as prompt the user 11 to address any states that might have been missed in the initial definitions. For example, the ECM 52 depicted in FIG. 1 could be used for this purpose to enable the host computer 12 to automatically check the state transition table 60 for a lack of consistency and/or completeness. As part of this possible implementation, the host computer 12 could be configured to check the validity of the various state transitions per event type as noted above, and to examine for states that belong to a certain container or containers (see FIG. 5). Highlighting critical events and critical states would help the user 11 properly identify state transitions from critical to non-critical state in response to the various events. Also note that filters may be used, or marking of critical events, critical states, and their intersection, and the ability to edit events and super-events from with the page, etc.

CUSTOMIZED QUERIES: the user 11 of the host computer 12 depicted in FIG. 1 may also perform customized queries as part of the present approach. This capability enables further stress-testing of the state transition table 60 of FIG. 7 during design and development of finite state models, allowing the user 11 to explore a myriad of possible event combinations that the modeled system could conceivably encounter during actual operation. This could include receiving a customized event query from the user 11 via the host computer 12, with the customized event query describing one or more hypothetical combinations of the events. The host computer 12 could determine results of the event query and update the populated state transition table 20 of FIG. 1 with the results.

To this end, a simplified query screen 70 is illustrated in FIG. 8 having add and delete buttons 71 (+,−), “Event Type” buttons 72, “Event Name” buttons 73, and “Value” buttons 74. Using the query screen 70 or a similar interface, the user 11 could construct multiple combinations of events, whether alone, in a particular sequence, or as the above-described super-events. The user 11 could select an interesting combination, name it, and save it as a new line in the state transition diagram. The host computer 12 may then update lines in the state transition table 60 (FIG. 7) that the user 11 may thereafter view and evaluate for omitted critical traits as set forth above. This approach would help guide the user 11 toward overlooked or omitted traits, at least some of which could be considered function-critical and thus deserving of a specific entry or entries in the state transition table 60 and state transition diagrams stemming therefrom.

Referring now to FIG. 9, the method 100 of the present disclosure is shown in simplified form as being organized into discrete logic blocks. Each logic block in turn represents a particular process step, function, or subprocess to be performed by the host computer 12 of FIG. 1 when executing the present method 100. That is, the memory 54 of the host computer 12 is programmed with or otherwise includes an instruction set that is executable by the processor(s) 53. As noted above, the host computer 12 could be embodied as multiple digital computer systems or processing nodes, e.g., processing nodes 12A, 12B, . . . , 12N of FIG. 1A, e.g., as part of a distributed computing network, or the host computer 12 could be a standalone device such as a laptop or user workstation. Thus, the constituent logic blocks of FIG. 9 may be implemented as machine-readable code that is executed by the host computer 12 or one or more of the processing nodes 12A, 12B, . . . , 12N, without limitation.

Beginning with block B102 (“REC (15)”), the method 100 entails receiving the system traits 15 from the user 11 illustrated in FIG. 1. The system traits 15 could include user-defined states of the modeled system, along with various state transitions, triggering events, and possibly other traits. Block B102 could include presenting a menu of the possible states and events via the display screen 14, e.g., by displaying the menu as an intuitive drop-down list, with the display screen 14 and/or the host computer 12 of FIG. 1 being configured to receive touch and/or keyboard inputs from the user 11, with such inputs being indicative of the system traits. The host computer 12 could then determine the system traits 15 using the touch or keyboard inputs, for instance by reading user entries or selections from the drop-down list.

Depending on the application, receiving the system traits 15 could entail receiving user-initiated events, automatically-occurring events, external or environmental events, and fault-triggered events of the modeled system. Non-limiting exemplary user-initiated events when the modeled system is a motor vehicle having automated drive system capabilities, for instance, could include accelerator and brake pedal position/force, steering inputs, HMI button or knob states, etc. Automatically-occurring events could include timer, sensor, fault-triggered, while external/environmental could include roads, weather, etc.

At block B102, therefore, the user 11 of FIG. 1 assigns event rules states, escalations or transitions between different states, classes (e.g., line weights, styles, and colors for use in constructing a corresponding state transition diagram), etc. The defined states and events/inputs are used to create an empty state table, for which the user 11 will ultimately select states using a drop-down list or menu. The method 100 proceeds to block B104 after the host computer 12 has received the system traits 15.

Block B104 (“GEN STTi”) includes generating the initial state transition table 19 of FIG. 1 in response to receipt of the system traits 15, with this action performed by operation of the host computer 12. The initial state transition table 19 is indexed, i.e., referenced on corresponding row/column axes, by a complete population of states and events of the modeled system, and then partially-populated with the system traits 15 as entered by the user 11 at block B102. The initial state transition table 19 of block B104 possibly lacks some or all of the assigned states of the exemplary state transition table 60 shown in FIG. 7, i.e., the initial state transition table 19 is substantially blank, awaiting further data entry by the user 11. Method 100 then proceeds to block B106.

At block B106 (“GEN STTP”), the method 100 includes populating the initial state transition table 19. This action occurs in response to the set of user inputs 16 of FIG. 1 and includes auto-generating the populated state transition table 20 via the host computer 12. Here, the user inputs 16 are used to fill in the various states of the state transition diagram 19, thus creating an output more akin to the state transition diagram 60 of FIG. 7. Method 100 proceeds to block B108 once the populated state transition table 20 has been successfully auto-generated by the host computer 12.

As part of block B106 or in a subsequent step, the method 100 may include receiving, via the host computer 12, one or more containers of meaning (“containers”) in which two or more of the assigned states are grouped together, and also translating such user-assigned containers into a corresponding state hierarchy. As noted above, this action could entail displaying the intuitive drag-and-drop graphic 56 of FIG. 5 to the user 11 via the display screen 14, and thereafter receiving the containers as a user response to the drag-and-drop graphic 56. The host computer 12 could then confirm validity of the various state transitions per event type in each respective one of the containers, e.g., using the ECM 52 of FIG. 1 and programmed validity references or criteria. The host computer 12 could possibly communicate a validity confirmation status signal to the user 11 in response to confirming the validity of the state transitions per event type, e.g., as part of the alert signal (CC₂₂) of FIG. 1. Method 100 then proceeds to block B108.

At block B108 (“T_{CRIT}=T?”), the host computer 12 next performs an error-checking routine on the populated state transition table 20. This action occurs using predetermined error-checking criteria recorded in memory 54 and accessible by the ECM 52 (FIG. 1), and may include searching the populated state transition table 20 for an omitted transition. Events, super-events, and states defined in the modeled system will appear in the transition table 20. Transitions are considered omitted within the scope of block B108 if the transition has not been filled in after the state transition table has been populated. Also, some errors may be identified on the basis of the container's identity or the state and event criticality level. Omitted critical transitions could be highlighted in the populated state transition table 20 as noted above to guide the user 11 into further consideration. For example, the host computer 12 could create a color-coded background, outline, or text color for certain transitions in the populated state transition table 20 to draw the user's attention to such transitions. As the host computer 12 makes all possible combinations of states and events explicit, the user 11 must fill in every cell, thus protecting against inadvertent omissions of transitions. The method 100 thereafter proceeds to block B109 when the host computer 12 affirmatively detects an omitted transition, and to block B112 in the alternative when the host computer 12 does not detect omitted transition.

Block B109 (“ALRT”) includes communicating an alert to the user 11 in response to the omitted transition. For example, the host computer 12 could display a visual alert message or graphic on the display screen 14 of FIG. 1, thereby giving the user 11 an immediate visual indication of the omitted critical trait. Alerts could be augmented with auditory or haptic feedback in some implementations. Graphics could include highlighted portions of the populated state transition table 20 to draw the user's attention to omitted traits, as noted above, some of which may be function-critical and thus important to design into the FSM of the modeled system. Method 100 then proceeds to block B110.

At block B110 (“UPDT (16)”), the host computer 12 shown in FIG. 1 may receive updated user inputs 16 from the user 11 to fill in the populated state transition table 20, thereby generating an updated version of the populated state transition table 20. In this block or one of the previously described blocks, the host computer 12 could receive one or more user-defined compound events as a combination of events as described above, and then update the populated state transition table 20 with the user-defined compound event(s).

Block B110 could optionally include receiving a customized event query from the user 11 via the host computer 12, as described above with reference to FIG. 8, with the customized event query describing one or more hypothetical combinations of the events. In response to receipt of such queries, the host computer 12 could determine results of the event queries and update the populated state transition table 20 with the results. The method 100 thereafter returns to block B106 which is described above. Blocks B102-B110 are therefore intended herein to be iterative, with the user 11 being prompted to refine the populated state transition table 20 through multiple iterations. This occurs until the user 11 is satisfied with the completeness and accuracy of the populated state transition table 20, or until the host computer 12 of FIG. 1 no longer detects errors or omissions in the populated state transition table 20.

Block B112 (“GEN STTF”) includes generating the final state transition table 21 of FIG. 1 as an output file. The final state transition table 21 in an optimal implementation of the method 100 would include every possible state, state transition, and event/event combination of the modeled system, and would also encompass function-critical states relevant to the particular modeled system. In keeping with the non-limiting motor vehicle example set forth above, for instance, the host computer 12 and execution of the method 100 would ensure that automated driver protection systems, stability, traction, steering, braking, lane keeping, and other possible automated driver assist functions are fully considered, e.g., when developing HMI software for use by an operator of such a motor vehicle.

While it is conceivable that some non-critical functions could be omitted for complex modeled systems, the present approach should fully capture function-critical behavior of the modeled system. In this manner, the final state transition table 21 is ready for use in developing an actual production-ready system. As appreciated by those skilled in the art, an error-tested and complete version of the final state transition table 21 may be used to develop corresponding state transition diagrams and underlying computer code, such as to program an HMI device or control system to perform various actions in response to dynamically changing circumstances. Likewise, the actual system will be less likely to enter non-defined or terminal states having no exit, or resulting in racing or competing conditions in which the state transition outcome may vary in an unpredictable manner.

The solutions of the present disclosure therefore provide the user 11 of FIG. 1 with an improved data entry method that aids in the design and decision tree construction of complex systems. Function-critical systems in particular often consist of extremely complex behaviors given their numerous states, conditions, alerts, warnings, conditionals, and escalation protocols. Using the host computer 12 and its programmed functionality as set forth above, the user 11 is intuitively guided by automated emphasis on critical states and events. The user 11 is likewise encouraged to explore function-critical combinations of events (super-events) while highlighting potential errors. If critical states or events are missed, the host computer 12 is configured to alert the user 11 to this fact, thus prompting further iterations of the method 100. These and other attendant benefits will be appreciated by those skilled in the art in view of the disclosure.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method for generating a populated state transition table for a modeled system, comprising:
receiving system traits via a host computer from a user, wherein the system traits include states, state transitions, and events of the modeled system;
generating an initial state transition table in response to receipt of the system traits, the initial state transition table being partially-populated by the system traits;
populating the initial state transition table, via the host computer, in response to a set of user inputs from a user of the host computer, to thereby auto-generate the populated state transition table;
error-checking the populated state transition table using predetermined error-checking criteria, including searching the populated state transition table via error-checking logic of the host computer for an omitted critical trait of the modeled system; and
communicating an alert to the user of the host computer in response to the omitted critical trait.

2. The method of claim 1, wherein receiving the system traits includes receiving User-initiated events, System-triggered events, and Timeout events of the modeled system.

3. The method of claim 1, further comprising:
iteratively performing the method until the host computer does not detect the omitted critical trait; and
outputting the populated state transition table as a final state transition table once the host computer does not detect the omitted critical trait.

4. The method of claim 1, further comprising:
presenting a menu of possible states and events of the modeled system to the user via a display screen of the host computer; and
determining the system traits via the host computer using touch or keyboard inputs.

5. The method of claim 4, further comprising:
displaying the menu as a drop-down list, wherein receiving the system traits includes recording user entries or selections from the drop-down list.

6. The method of claim 1, further comprising:
receiving, via the host computer, one or more containers of meaning in which two or more of the states are grouped together; and
translating the containers of meaning into a state hierarchy.

7. The method of claim 6, further comprising:
displaying an intuitive drag-and-drop graphic or editing tools to the user via a display screen of the host computer; and
receiving the one of more containers of meaning as a user response to the drag-and-drop graphic or editing inputs from the editing tools.

8. The method of claim 6, further comprising:
confirming, via the host computer, a validity of the state transitions per event type in each respective one of the containers of meaning; and
communicating a validity confirmation status to the user in response to confirming the validity of the state transitions per event type.

9. The method of claim 1, further comprising:
receiving a user-defined compound event as a combination of the events; and
updating the populated state transition table with the user-defined compound event.

10. The method of claim 1, further comprising:
receiving a customized event query from the user via the host computer, the customized event query describing one or more hypothetical combinations of the events;
determining results of the event query via the host computer; and
updating the populated state transition table with the results.

11. A modeling system for generating a populated state transition table for a modeled system, the modeling system comprising:
a host computer having a non-transitory computer-readable storage medium (“memory”) and a processor, the memory including an instruction set that is executable by the processor; and
a display screen in communication with the host computer, wherein execution of the instruction set by the processor causes the host computer to:
receive system traits from a user of the host computer, wherein the system traits include states, state transitions, and events of the modeled system;
generate an initial state transition table in response to receipt of the system traits, the initial state transition table being partially-populated by the system traits;
populate the initial state transition table in response to a set of user inputs, to thereby auto-generate the populated state transition table;
error-check the populated state transition table using predetermined error-checking criteria, including searching the populated state transition table via error-checking logic of the host computer for an omitted critical trait of the modeled system; and
communicate an alert to the user of the host computer in response to the omitted critical trait.

12. The modeling system of claim 11, wherein the execution of the instruction set by the processor causes the host computer to:
receive the system traits as user-initiated events, automatically-occurring events, external events, and fault-triggered events of the modeled system.

13. The modeling system of claim 11, wherein the execution of the instruction set by the processor causes the host computer to:
iteratively perform a method until the host computer does not detect the omitted critical trait, the method including receiving the system traits, generating the initial state transition table, populating the initial state transition table, error-checking the populated state transition table. and communicating the alert to the user; and
output the populated state transition table as a final state transition table once the host computer does not detect the omitted critical trait.

14. The modeling system of claim 11, wherein the execution of instruction set by the processor causes the host computer to:
present a menu of possible states and events of the modeled system via a display screen of the host computer, including displaying the menu as a drop-down list;
determine the system traits via the host computer using touch or keyboard inputs; and
record user entries or selections from the drop-down list in response to the touch or keyboard inputs.

15. The modeling system of claim 11, wherein the execution of the instruction set by the processor causes the host computer to:
receive one or more containers of meaning in which two or more of the states are grouped together; and
translate the containers of meaning into a state hierarchy.

16. The modeling system of claim 15, wherein the execution of the instruction set by the processor causes the host computer to:
display an intuitive drag-and-drop graphic to the user via the display screen; and
receive the one of more containers of meaning as a user response to the drag-and-drop graphic.

17. The modeling system of claim 15, wherein the execution of the instruction set by the processor causes the host computer to:
confirm a validity of the state transitions per event type in each respective one of the containers of meaning; and
communicate a validity confirmation status to the user in response to confirming the validity of the state transitions per event type.

18. The modeling system of claim 11, wherein the execution of the instruction set by the processor causes the host computer to:
receive a user-defined compound event as a combination of the events; and
update the populated state transition table with the user-defined compound event.

19. The modeling system of claim 11, wherein the execution of the instruction set by the processor causes the host computer to:
receive a customized event query from the user via the host computer, the customized event query describing one or more hypothetical combinations of the events;
determine results of the event query via the host computer; and
communicate the results of the event query to the user.

20. A computer-readable storage medium on which is recorded instructions that are executable by a processor, wherein execution of the recorded instructions causes the processor to:
receive system traits from a user of a host computer, wherein the system traits include states, state transitions, and events of the modeled system;
generate an initial state transition table via the host computer in response to receipt of the system traits, the initial state transition table being partially-populated by the system traits;
populate the initial state transition table in response to a set of user inputs, to thereby auto-generate the populated state transition table;
error-check the populated state transition table using predetermined error-checking criteria, including searching the populated state transition table via error-checking logic of the host computer for an omitted critical trait of the modeled system; and
communicate an alert to the user of the host computer in response to the omitted critical trait.
